(19) United States
(12) Patent Application Publication
(10) Pub. No.: US 2007/0148477 A1
(43) Pub. Date: Jun. 28, 2007

(54) ALUMINUM AND PLASTIC COMPOUND DECORATIVE PLATE

(76) Inventor: Zhenyi Guo, Quanzhou City (CN)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/612,753

(22) Filed: Dec. 19, 2006

Related U.S. Application Data
(60) Provisional application No. 60/743,079, filed on Dec. 26, 2005.

(51) Int. Cl. B32B 15/04

(52) U.S. Cl. 428/457

(57) ABSTRACT

A new aluminum and plastic compound decorative plate comprises a substrate board and an aluminum and plastic sheet adhered to the substrate board by in-between adhesive layer. Because the compound plate comprises two layers, there is no need to make the substrate board with high thickness. Therefore, the compound plate not only lightens the weight but also saves the stone material. Moreover, compared with the pure stone plate in prior art, the aluminum and plastic sheet makes the compound plate has better rigidity, high intensity and durability.

### CROSS REFERENCE TO RELATED APPLICATIONS

This application claims the benefit of U.S. Provisional Application Ser. No. 60/743,079 filed Dec. 26, 2005 which is hereby incorporated by reference in its entirety.

### TECHNICAL FIELD

The present disclosure belongs to constructing material, it relates to a compound plate, and more particularly, it relates to a new aluminum and plastic compound decorative plate.

### BACKGROUND

In modern architecture industry, many stone material such as marble and granite which are attractive and durable are conventionally used for the decoration of the floor, internal wall and external wall, etc. However, the stone plate has high thickness in order to have enough intensity, which produces many problems such as great weight, fragility and waste a great deal of the mineral resources.

### SUMMARY

In order to overcome the above-indicated problems, the object of the present invention is to provide an aluminum and plastic compound plate which has simple structure and can be processed conveniently. The aluminum and plastic compound plate according to the present invention is also durable and light in weight.

According to the object of the present invention, there is provided a new aluminum and plastic compound decorative plate comprises a substrate board and an aluminum and plastic sheet adhered to the substrate board by in-between adhesive layer.

Because the compound plate comprises two layers, there is no need to make the substrate board with high thickness. Therefore, the compound plate not only lightens the weight but also saves the stone material. Moreover, compared with the pure stone plate in prior art, the aluminum and plastic sheet makes the compound plate has better rigidity, high intensity and durability.

### BRIEF DESCRIPTION OF THE DRAWINGS

The accompanying drawings, which are incorporated in and constitute a part of specification, illustrate an exemplary embodiment of the present invention and, together with the general description given above and the detailed description of the preferred embodiment given below, serve to explain the principles of the present invention.

FIG. 1 illustrates a configuration of the present invention.

### DETAILED DESCRIPTION

While the claims are not limited to the illustrated embodiments, an appreciation of various aspects of the present invention is best gained through a discussion of various examples thereof. Referring now to the drawings, illustrative embodiments will be described in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limiting or restricting to the precise form and configuration shown in the drawings and disclosed in the following detailed description.

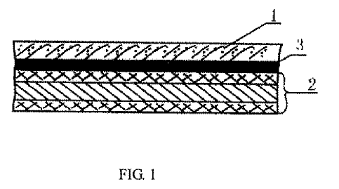

A new aluminum and plastic compound decorative plate as shown in FIG. 1, the aluminum and plastic sheet 2 is adhered to the substrate board 1 by the adhesive layer 3 between them.

Because the compound plate comprises two layers, there is no need to make the substrate board with high thickness. Therefore, the compound plate not only lightens the weight but also saves the stone material. Moreover, compared with the pure stone plate in prior art, the aluminum and plastic sheet makes the compound plate has better rigidity, high intensity and durability.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A new aluminum and plastic compound decorative plate comprising:
a substrate board and an aluminum and plastic sheet adhered to the substrate board by in-between adhesive layer.
